(19) United States
(12) Patent Application Publication
(10) Pub. No.: US 2022/0069687 A1
(43) Pub. Date: Mar. 3, 2022

(54) MINIATURE STEP MOTOR WITH SHOELESS STATOR AND PREWOUND BOBBINS

(71) Applicant: Lin Engineering, Inc., Morgan Hill, CA (US)

(72) Inventors: Ted T. Lin, Saratoga, CA (US); Jinping Liu, Shanghai (CN)

(73) Assignee: Lin Engineering, Inc., Morgan Hill, CA (US)

(21) Appl. No.: 17/010,118

(22) Filed: Sep. 2, 2020

(51) Int. Cl. H02K 17/12; H02K 37/14; H02K 15/02

(52) U.S. Cl. CPC H02K 17/12; H02K 37/14; H02K 15/08; H02K 2213/03; H02K 15/02

(57) ABSTRACT

A two-phase stepper motor with a permanent magnet (PM) rotor and a modified hybrid-type stator is provided. The modified hybrid stator can be manufactured even at the smaller motor size because it employs shoeless, straight stator poles without stator teeth and with bobbin coils that are pre-wound outside the motor and easily inserted over each of the stator poles. Each bobbin may be an elongated continuous belt of insulative material with a hollow interior that forms a sleeve that fits around its corresponding stator pole. Conductive wire wound around the sleeve forms the stator coils. Edges of the sleeve may have exterior flanges at radially inner and outer ends of the stator pole to hold windings in place and keep the sleeve from bowing outward. This stator construction allows the motor to be miniaturized so that the PM rotors can be 13 mm diameter or less.

### TECHNICAL FIELD

The present invention relates to step motors, that is, electric motor structures designed to rotate step by step between established electromagnetic detent positions, especially step motors having permanent magnet (PM) type rotors and hybrid stators, and in particular to any having design features that permit manufacture of ever smaller motors.

### BACKGROUND ART

Demand for smaller motors is high for a number of applications, such as medical and laboratory equipment (e.g. centrifuges), pumps, fans, printers and copiers, material handling, as well as many positioning or speed control devices used in motion control. Low noise is also required in many of these applications, and so a major design goal is not only to reduce motor size but at the same time also to reduce motor noise and vibration. Most step motors, which are widely used where precise positioning is a requirement, are designed for low speed operation. But increasingly there is demand (e.g. in centrifuges) for higher step motor speeds. In either case, whether operated at low or high speed, there is demand for both miniaturization and low noise in such step motors.

A popular step motor size uses a rotor with a diameter of about 25 mm. There are challenges to designing even smaller motors, especially those with rotors smaller than 13 mm diameter. Both manufacturability and performance (e.g. adequate torque) reach extreme difficulty in both rotor and stator design for 8 mm diameter steppers. At present, 8 mm diameter motors exist only for brushless DC motors and 2-phase can-stack permanent magnet (PM) steppers having low resolution and low torque characteristics. For step motors of any given resolution or step angle, as the rotor diameter decreases so too does the torque that the motor can produce.

This is especially true for the hybrid stepper, which is designed for high step resolution and accuracy and is widely used in precision positioning devices. The popular two-phase 1.8° stepper requires a rotor with 100 magnetic poles (50 N and 50 S). With a typical 25 mm-diameter rotor, the width of individual rotor magnets forming the poles would be only [25 mm×π/100]≈0.785 mm. So instead, the rotor typically comprises two sections, each with 50 raised teeth around their respective circumferences, sandwiching a disc magnet and with the teeth in the respective sections offset from each other by half of the tooth separation. The teeth in one section form the N poles and those in the other form the S poles, giving a long three-dimensional flux path (i.e. one that includes an axial component) in the completed motor. The stator for a hybrid stepper is a lamination design with windings around a set of radially inward projecting stator poles (typically 4 or 8 in number for a two-phase stepper). The stator poles terminate in pole shoes that both hold the windings in place and have stator teeth which interact magnetically with the rotor teeth across a small gap. Attempting to reduce the size of such hybrid steppers leads to several consequences. In the rotor, the disc magnet shrinks as the square of the rotor diameter whose corresponding loss in magnetic strength can be only partially compensated by increasing the disc's thickness. The width of the rotor poles decreases only linearly but, even so, at a 13 mm diameter the pole widths in a 100-pole rotor are reduced to just 0.408 mm, which is too narrow to generate an effective magnetic flux that is usable. For the stator, manufacturability becomes a problem with shrinking motor sizes because the winding needle used to wind the conductive wire around the stator poles becomes no longer able to fit between the pole shoes for any motors smaller than about 13 mm diameter.

A three-phase 3.75° stepper can be made that requires only 32 rotor poles (16 N and 16 S) and a stator needing only 3 teeth per stator pole. This type of motor can be made with a rotor of only 8 mm diameter (rotor pole width≈0.785 mm, the same as the 2-phase 1.8° stepper of 25 mm diameter) while still having just enough space between the stator shoes for the stator winding needle to pass. This motor can be made as a PM step motor using permanent magnet strips, as e.g. in U.S. Pat. No. 5,386,161. While it tries to keep a reasonably high step resolution) (3.75°) that is acceptable for some (but not all) positioning applications, the speed and torque are limited in three-phase steppers.

Can-stack PM steppers are usable in low torque, low resolution applications only. Brushless DC motors can be used for high speed applications but fail to operate at low speeds and require feedback from positioning sensors and closed-loop control for commutation of the drive current.

If it could be achieved, a miniature (<13 mm diameter) two-phase stepper motor with a range of operating speeds and adequate torque would be highly desirable.

### Summary Disclosure

A miniature two-phase stepper motor with a permanent magnet (PM) rotor and a modified hybrid-type stator is provided. The modified hybrid stator can be manufactured even at the smaller motor size because it employs essentially shoeless, straight stator poles without stator teeth and with bobbin coils that are pre-wound outside the motor and easily inserted over each of the stator poles. Using a PM rotor means that the magnetic flux path is two-dimensional (without any axial component), resulting in a shorter flux path and smaller reluctance. This yields a smaller winding inductance and faster current rise to maintain torque at high speeds. Although full step angles range from 9° to 90° in the miniature motors, it can run at high speeds, and operate smoothly at low speed by means of micro-stepping control.

More specifically, a two-phase permanent magnet step motor is provided, that comprises a PM rotor and a hybrid stator assembly. The rotor has an equal number Nr of magnetic north and magnetic south poles defining a fundamental step angle θ=90°/Nr. In a PM rotor, the rotor poles are formed by strips of rare-earth magnet material arranged axially on the rotor. The magnetic poles face radially outward from the rotor and are arranged alternately around a circumference of the rotor.

The hybrid stator assembly has a number Ns of straight, shoeless stator poles facing radially inward toward the rotor, where Ns is divisible by four and a ratio Nr/Ns=n/4, n being an odd integer. Each of the straight, shoeless stator poles has a bobbin. The bobbins are pre-wound with conductive stator coils and fit around the respective straight, shoeless stator poles.

For example, each bobbin may be an elongated continuous belt of insulative material with a hollow interior that forms a sleeve that fits around its corresponding stator pole. Conductive wire wound around the sleeve forms the stator coils. Edges of the sleeve may have exterior flanges at radially inner and outer ends of the stator pole to hold windings in place and keep the sleeve from bowing outward.

The stator construction, with its shoeless, straight stator poles and pre-wound bobbins fit over those poles, allows the motor to be miniaturized so that motors whose rotors have at most 13 mm diameter and especially 8 mm diameter.

The rotor may have an Nr value of 10 or less (that is, Nr N poles plus Nr S poles, so 2×Nr total rotor poles), but despite the low resolution (9° or more full step Size), the motor can be micro-stepped using variable drive current amplitude applied in successive phases through the stator winding's for smooth operation.

### BRIEF DESCRIPTION OF THE DRAWINGS

FIG. 1 is a side sectional view of a conventional hybrid stepper of the prior art.

FIG. 2A is a perspective view of the stator assembly for the hybrid stepper of FIG. 1.

FIG. 2B is a cutaway perspective view of the stator assembly of FIG. 2A with a hybrid rotor.

FIG. 3 is a perspective view of a typical hybrid rotor for a 30° low resolution stepper in the prior art.

FIG. 4 is a perspective view of a permanent magnet rotor, here for a 30° full step angle, for use in the present invention.

FIG. 5 is a cross-sectional view of a step motor with a permanent magnet rotor and with a conventional stator having pole shoes as in the prior art.

FIG. 6 is a cross-sectional view of a stator core lamination with straight shoeless stator poles for use in the present invention.

FIGS. 7A and 7B are side plan and end views of a bobbin coil that when pre-wound with stator windings is fitted over the straight stator poles of FIG. 6 in accord with the present invention.

FIG. 8 is a perspective view of an assembled step motor having the stator core of FIG. 6 with pre-wound bobbin coils as in FIGS. 7A-7B and fitted with a PM type rotor like that in FIG. 4.

### DETAILED DESCRIPTION

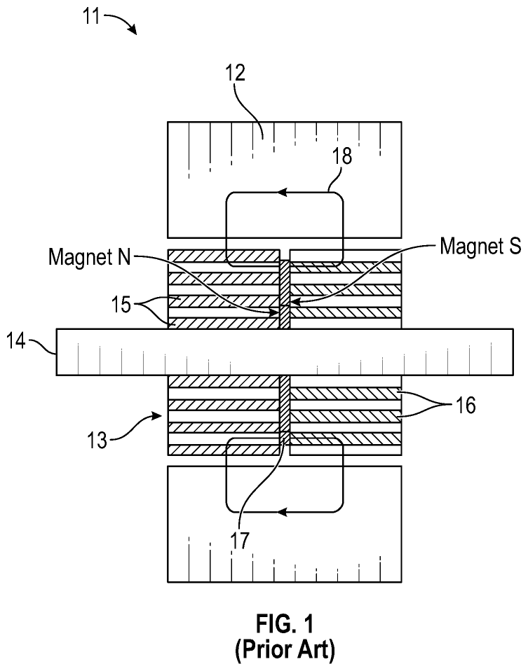

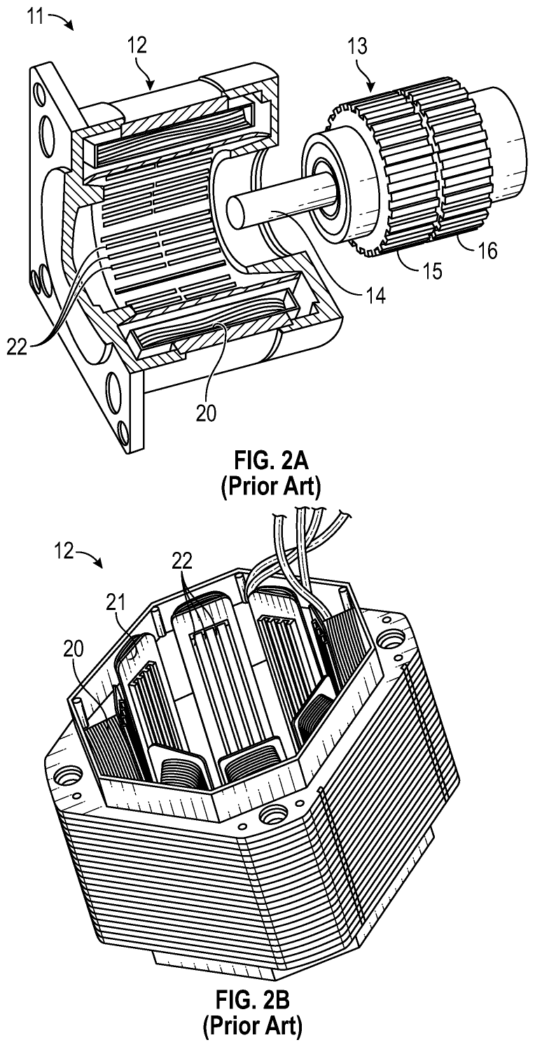

With reference to FIGS. 1, 2A and 2B, a conventional hybrid step motor 11 of the prior art is shown by way of comparison. This step motor includes a stator assembly 12 and a hybrid-type rotor 13. The rotor 13 is mounted on an axial shaft 14 that is supported for rotation within the stator assembly 12, e.g. via a pair of precision bearings.

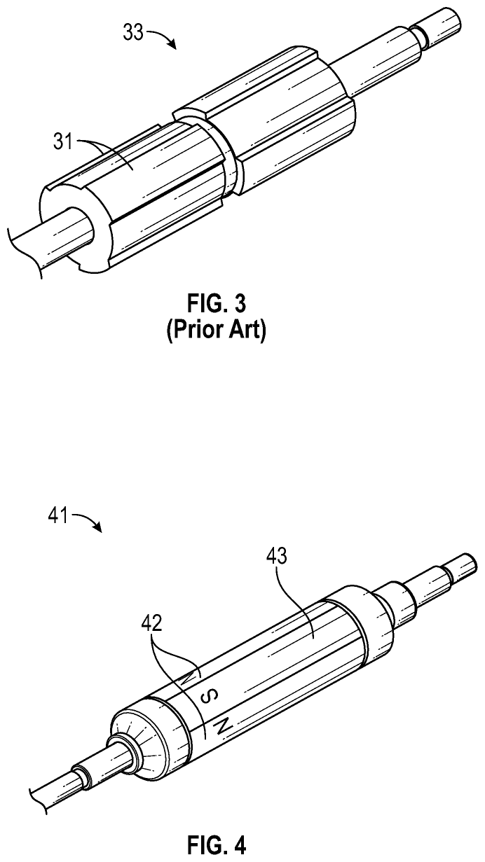

The hybrid-type rotor has two parts with respective rotor teeth 15 and 16 that sandwich a disc magnet 17. The teeth 15 in one of the rotor parts are circumferentially offset by one-half pitch relative to the teeth 16 in the other of the rotor parts, so that teeth 15 define magnetic N rotor poles and teeth 16 define magnetic S rotor poles. Another hybrid-type rotor with fewer rotor teeth 31 is shown in FIG. 3. This kind of hybrid rotor arrangement provides for a long three-dimensional magnetic flux path 18 through the motor 11, resulting in greater reluctance and winding induction, and slower current rise time between successive phases than comparable motors using a PM-type rotor.

The stator assembly 12 has a stator core with a set of stator poles 20 directed radially inward toward the rotor, each pole 20 terminating in a corresponding stator shoe 21 having a set of stator teeth 22. The stator poles 20 have respective conductive windings that can be driven with applied current to magnetize the poles with successive magnetic polarities for the different phases. Although the conductive wires that form the windings have an insulative coating to prevent electrical shorts, the space between the poles may also have an insulative plastic insert to further separate the stator core material from the windings.

With reference to FIG. 4, a PM-type rotor may be used in place of a hybrid rotor if the number of rotor poles is relatively small (e.g. Nr=10 or less for 20 or fewer total rotor poles, each 18° or more wide). A PM rotor 41 has N and S rotor poles 42 and 43 that are formed using strips of rare-earth magnet material arranged axially on the rotor 41. The magnetic poles 42 and 43 face radially outward from the rotor and are arranged with N and S facing polarities alternately around the circumference of the rotor 41. Typical magnetic material for PM rotors are sintered neodymium-iron-boron or samarium-cobalt.

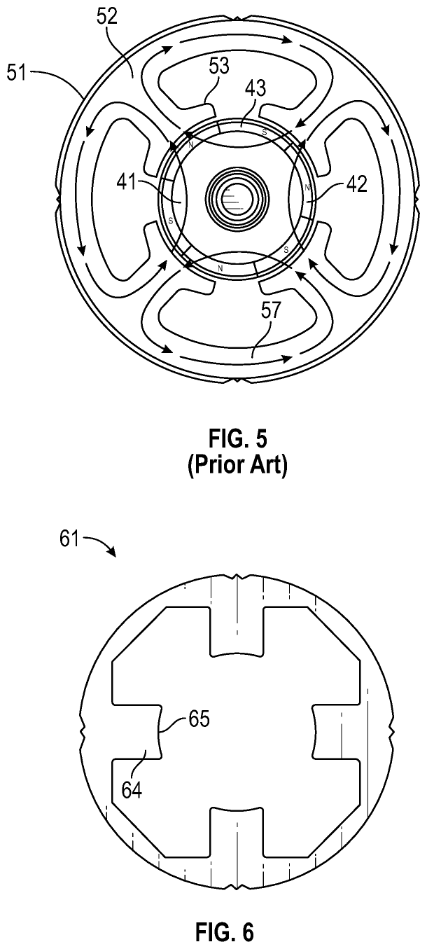

FIG. 5 shows a cross-sectional view for a 30° stepper with 2-phases energized flux paths 57 passing on the face of the stator 51. The rotor 41 is a PM-type rotor with strips of magnetic material forming alternating N rotor poles 42 and S rotor poles 43, three poles of each polarity and six rotor poles in total. The stator 51 has four conventional hybrid stator poles 52 that terminate in corresponding stator shoes 53. The shoes widen the stator poles 52 for maximum magnetic interaction with the corresponding rotor poles 42 and 43, but also help to hold in place the windings (not shown) that pass axially (vertically through the sheet). The flux path 57 for the energized stator poles 52 passes without any axial component, that is in two dimensions only.

With reference to FIG. 6, a stator core 61 in accord with the present invention has a set of radially inward directed, straight, shoeless stator poles 64, here four in number (but 8 or even 12 poles are possible, as long as the number of stator poles is divisible by 4). The stator poles 64 terminate in a slightly concave toothless surface 65 that collectively follow a circular cylindrical path that is only slightly larger than the rotor surface. Thus, rotor and stator elements face each other across a very small gap of only a few hundred micrometers. For maximum magnetic interaction, the width of the straight poles is made as wide as possible while still allowing pre-wound bobbins to all fit over the poles 64.

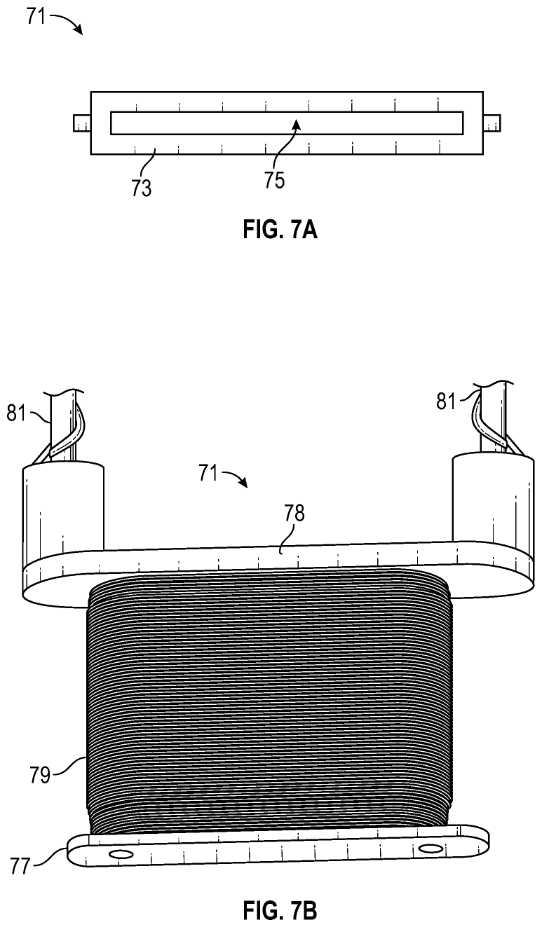

FIGS. 7A and 7B show aplastic bobbin 71 for placement over the straight stator poles after having been pre-wound with conductive windings. The bobbin 71 can be seen to comprise an elongated continuous belt 73 of rigid polymer material with a hollow interior that forms, a sleeve 75. The sleeve 75 is slightly longer than the axial dimension of the stator poles and is slightly wider than the circumferential width dimension of the stator poles, so that sleeve 75 can easily fit around a stator pole with minimal play. Exterior flanges 77 and 78 extend circumferentially from the radially inner and outer edges of the sleeve 75. The flanges 77 and 78 function primarily to hold the windings 79 in place, but unlike stator shoes are not a soft magnetic material. The flanges also reinforce the rigidity of the sleeve to keep it from bowing outward when the conductive wires 79 are wound. For each pre-wound bobbin, the windings 79 connect at their two ends to respective terminals 81 located at one axial end of the bobbin 71. Once the bobbins are inserted over the set of stator poles, the terminals 81 can be electrically coupled in any of several well-known configurations to receive applied current from driver to operate the motor. Applying drive current in successive phases through the stator windings cause the motor to step. Using variable drive current amplitude, the motor can pass gradually through the successive phases in a mode known as micro-stepping for smooth operation despite the large step sizes.

The permanent magnet rotor has an equal number Nr of magnetic north and south poles that defines a fundamental step angle θ=90°/Nr for 360°/Nr steps per revolution. For example, two north poles and two south poles outward facing in a 4-poles rotor will produce a 45°-step motor (Nr=2). Preferably Nr is at most ten (i.e., no more than 20 rotor poles in total), giving the motor good holding torque and capability for high operating speed. The hybrid-type stator for use in the present invention is both shoeless and toothless, with a number Ns of stator poles. Ns should be divisible by 4 for a two-phase motor. Additionally, the ratio Nr/Ns=n/4, where n is an odd integer. Preferably, the motor uses a 4-pole or 8-pole stator.

The following table illustrates a number of possible rotor-stator pole combinations for two-phase step motors in accord with the present invention.

| | Number of | Odd | Number of |
|---|---|---|---|
| Fundamental | Rotor Poles | Integer | Stator Poles |
| Step Angle θ | 2 × Nr | n | Ns |
| 9° | 20 | 5 | 8 |
| 10° | 18 | 9 | 4 |
| 11.25° | 16 | 1 | 32 |
| ≈12.85° | 14 | 7 | 4 |
| 15° | 12 | 3 | 8 |
| 18° | 10 | 5 | 4 |
| 22.5° | 8 | 1 | 16 |
| 30° | 6 | 3 | 4 |
| 45° | 4 | 1 | 8 |
| 90° | 2 | 1 | 4 |

The preferred combinations are Nr=6 and Ns=8 for a 15° stepper; Nr=5 and Ns=4 for a 18° stepper; Nr=3 and Ns=4 for a 30° stepper, and Nr=1 and Ns=4 for a 90° stepper. The larger step angles allow the motor to operate at higher speeds. The motor speed is controlled by the step pulse, rate with no feedback or commutation system (open loop control system). Unlike brushless DC motors, the step motor can run smoothly at low speed via micro-stepping control.

As previously noted, in a conventional hybrid stepper two rotor sections are offset by of the tooth pitch, and a 3-dimensional magnetic flux path is formed, and magnetic flux passes in axial direction. With the use of a permanent magnet rotor in the present invention, the magnetic flux path is 2-dimensional, without magnetic flux in axial direction, resulting in shorter magnetic flux path and small reluctance. With the lower reluctance, the winding inductance is much smaller to allow for fast current rise in the stator to maintain the torque at the high speed.

Two-phase step motors in accord with the present invention, when operated at 2-phase ON, provides 100% coil and stator pole utilization. For a 45-degree step motor, all four magnetic rotor poles are 100% utilized to interact with the 8 stator poles. Likewise, for a 15-degree step motor, 8 of the 12 magnetic rotor poles interact directly with the stator effectively, while the remaining 4 magnetic rotor poles always repulse with the energized stator poles to act as a magnetic pusher to minimize the leakage flux from the energized stator. As a result, a highly efficient motor is created.

Because straight, shoeless stator poles are used with pre-wound bobbins for the coils, the motor can be made much smaller without having to contend with adequate space between stator pole shoes for a winding needle. All winding is conducted while the bobbins are outside of the stator and then slipped over the poles. 2-phase step motors having rotor diameters smaller than 13 mm are possible, including step motors with rotors as small as 8 mm diameter.

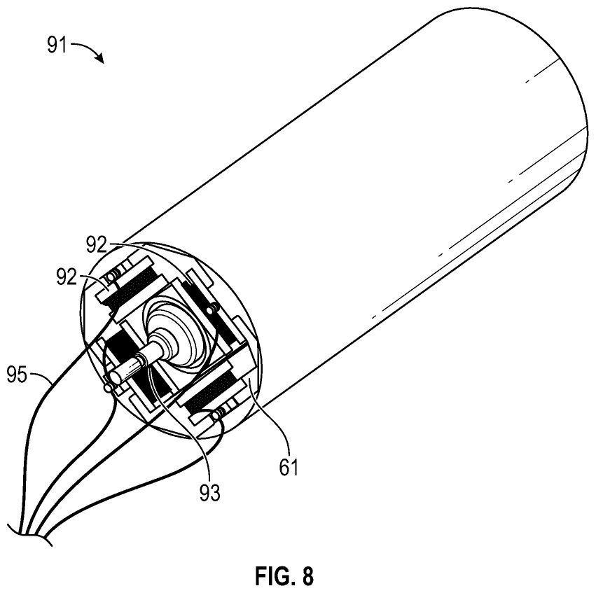

As seen in FIG. 8, an assembled step motor 91 in accord with the present invention can be seen to have a stator core 92 (like stator core 61 in FIG. 6) with pre-wound bobbins (as in FIGS. 7A-7B) which are fitted over each of the stator's shoeless poles. Terminal wires 95 from the windings are seen to come out of one end of the stator (although wires could come out of both ends, if desired). The stator 92 is fitted with a rotor 93 inside. This rotor 93 is a PM type rotor (like the rotor 41 in FIG. 4). The number of rotor and stator poles is per any of the possibilities set forth in the preceding table.

What is claimed is:

1. A two-phase permanent magnet step motor, comprising:
a permanent magnet rotor having an equal number Nr of magnetic north and magnetic south poles defining a fundamental step angle θ=90°/Nr, the magnetic poles facing radially outward from the rotor and arranged alternately around a circumference of the rotor; and
a hybrid stator assembly having a number Ns of straight, shoeless stator poles facing radially inward toward the rotor, wherein Ns is divisible by four and a ratio Nr/Ns=n/4, n being an odd integer, each of the straight, shoeless stator poles having a bobbin pre-wound with conductive stator coils, the bobbins fitting around the respective straight, shoeless stator poles.

2. A step motor as in claim 1, wherein rotor poles are formed by strips of rare-earth magnet material arranged axially on the rotor.

3. A step motor as in claim 1, the rotor has a diameter of at most 13 mm.

4. A step motor as in claim 3, wherein the rotor has a diameter of 8 mm.

5. A step motor as in claim 1, wherein Nr is at most 10.

6. A step motor as in claim 1, wherein each bobbin is an elongated continuous belt of insulative material with a hollow interior that forms a sleeve that fits around its corresponding stator pole, and conductive wire wound around the sleeve to form the conductive stator coils, edges of the sleeve having exterior flanges at radially inner and outer ends of the stator pole to hold windings in place and keep the sleeve from bowing outward.

7. A method of making two-phase permanent magnet step motor, comprising:
providing a hybrid stator assembly having a number Ns of straight, shoeless stator poles facing radially inward, wherein Ns is divisible by four;
providing a set of Ns bobbins, each bobbin being an elongated continuous belt of insulative material with a hollow interior that forms a sleeve that can fit around a corresponding stator pole, edges of the sleeve having exterior flanges to hold windings in place and keep the sleeve from bowing outward;
winding conductive wire wound around the sleeve to form conductive stator coils;
fitting the wound bobbins around the respective straight, shoeless stator poles; and
rotatably mounting a permanent magnet rotor having an equal number Nr of magnetic north and magnetic south poles defining a fundamental step angle θ=90°/Nr, a ratio Nr/Ns=n/4, n being an odd integer, the magnetic poles facing radially outward from the rotor toward the stator and arranged alternately around a circumference of the rotor.

8. The method as in claim 7, wherein rotor poles are formed by applying strips of rare-earth magnet material arranged axially on the rotor.

9. The method as in claim 7, wherein the rotor has a diameter of at most 13 mm.

10. The method as in claim 9, wherein the rotor has a diameter of 8 mm.

11. The method as in claim 7, wherein Nr is at most 10.
